(19) United States
(12) Patent Application Publication
(10) Pub. No.: US 2012/0032904 A1
(43) Pub. Date: Feb. 9, 2012

(54) TOUCH PANEL

(75) Inventors: Won Ha MOON, Gyunggi-do (KR); Jong Young LEE, Gyunggi-do (KR); Sang Hwa KIM, Gyunggi-do (KR); Yong Hyun JIN, Seoul (KR)

(73) Assignee: SAMSUNG ELECTRO-MECHANICS CO., LTD., Gyunggi-do (KR)

(21) Appl. No.: 13/189,167

(22) Filed: Jul. 22, 2011

(30) Foreign Application Priority Data
Aug. 9, 2010 (KR) 1020100076568

(51) Int. Cl. G06F 3/041

(52) U.S. Cl. 345/173

(57) ABSTRACT

Disclosed herein is a touch panel. The touch panel includes a transparent substrate and a plurality of transparent electrodes. The transparent electrodes are formed on one surface of the transparent substrate. Each of the transparent electrodes includes a touch part formed to have an identical width and a connection part configured in a stepped form along with the touch part and configured to connect the touch part with the transparent substrate.

### CROSS REFERENCE TO RELATED APPLICATION

This application claims the benefit of Korean Patent Application No. 10-2010-0076568, filed on Aug. 9, 2010, entitled “Touch Panel,” which is hereby incorporated by reference in its entirety into this application.

### BACKGROUND OF THE INVENTION

1. Technical Field

The present invention relates generally to touch panels.

2. Description of the Related Art

In general, touch panels are attached to the surfaces of display devices, such as Liquid Crystal Displays (LCDs), Plasma Display Panels (PDPs), Organic Light Emitting Diodes (OLEDs), and Active Matrix Organic Light Emitting Diodes (AMOLEDs). Touch panels are input devices, and generate signals corresponding to contact locations when an object, such as a finger or a pen, comes into contact with them.

Such touch panels are utilized in a variety of fields, including the fields of small-sized portable terminals, industrial terminals, and Digital Information Devices (DIDs), and are classified into the following types: resistive-type touch panels, capacitive-type touch panels, electromagnetic-type touch panels, Surface Acoustic Wave (SAW)-type touch panels, and infrared-type touch panels.

Meanwhile, various types of touch panels are employed in electronic products depending on the signal amplification, the differences in resolution, the difficulties of design and manufacturing technology, optical characteristics, electrical characteristics, mechanical characteristics, anti-environmental characteristics, input characteristic, durability and economic efficiency. Recently, resistive-type touch panels and capacitive-type touch panels have been the ones most widely used.

Resistive-type touch panels are configured such that a transparent conductive film is formed over an entire surface of a substrate and electrode terminals are disposed on the four corners of the transparent conductive film, and, when an alternating current (AC) signal is applied to a coordinate detection transparent conductive film, they detect currents flowing across current detection resistors disposed at the four corners and then detect touch coordinates using resistance ratios between a touch point and electrode terminals.

In contrast, the capacitive-type touch panels are configured such that X-direction detection cells and Y-direction detection cells are arranged on a transparent substrate, and they detect touch coordinates by detecting a capacitance value using a current value which is detected between an X-direction detection cell and a Y-direction detection cell when contact is made.

Conventional touch panels are generally configured such that the area ratio between electrodes varies for each touch section, as was shown in Korean Unexamined Patent Publication No. 2009-11244 and Korean Unexamined Patent Publication No. 2009-50988.

That is, since conventional touch panels are configured such that electrodes are formed to have different sizes for respective sections, they are problematic in that large vacant spaces are formed between the electrodes, thereby increasing the overall sizes of the touch panels.

### SUMMARY OF THE INVENTION

Accordingly, the present invention has been made keeping in mind the above problems occurring in the prior art, and the present invention is intended to provide a touch panel which has a small size.

According to the present invention, there is provided a touch panel, including a transparent substrate; and a plurality of transparent electrodes formed on one surface of the transparent substrate, each of the transparent electrodes including a touch part formed to have an identical width; and a connection part configured in a stepped form along with the touch part, and configured to connect the touch part with the transparent substrate.

The transparent electrodes may be formed to have different capacitance values.

The touch parts may be formed to have an identical thickness.

The touch parts may be formed to have different thicknesses.

The connection parts may be formed to have different widths.

The connection parts may be formed to have an identical thickness.

The connection parts may be formed to have different thicknesses.

The touch part and the connection part may be configured to have a T-shaped section.

The touch panel may further include a first wiring configured to connect ones of the transparent electrodes, arranged in each odd column or row, to each other; and a second wiring configured to connect ones of the transparent electrodes, arranged in each even column or row, to each other.

The first wiring and the second wiring may be disposed across spaces formed by the stepped form in which the touch part and the connection part are configured.

The first wiring and the second wiring may be disposed between the transparent electrodes.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view of a touch panel according to a preferred embodiment of the present invention;

FIGS. 2 and 3 are plan views showing the wiring of the touch panel of FIG. 1;

FIGS. 4 and 5 are sectional views showing the locations of the wirings of the touch panel of FIG. 1;

FIGS. 6 and 7 are sectional views showing application embodiments of the touch panel of FIG. 1; and

FIG. 8 is a sectional view of a touch panel according to another preferred embodiment of the present invention.

### DESCRIPTION OF THE PREFERRED EMBODIMENTS

If in the specification, detailed descriptions of well-known functions or configurations may unnecessarily make the gist of the present invention obscure, the detailed descriptions will be omitted.

The terms and words used in the present specification and the accompanying claims should not be limitedly interpreted as having their common meanings or those found in dictionaries, but should be interpreted as having meanings adapted to the technical spirit of the present invention on the basis of the principle that an inventor can appropriately define the concepts of terms in order to best describe his or her invention.

It should be noted that the same reference numerals are used as much as possible throughout the different drawings to designate the same or similar components.

Preferred embodiments of the present invention will be described in detail below with reference to the accompanying drawings.

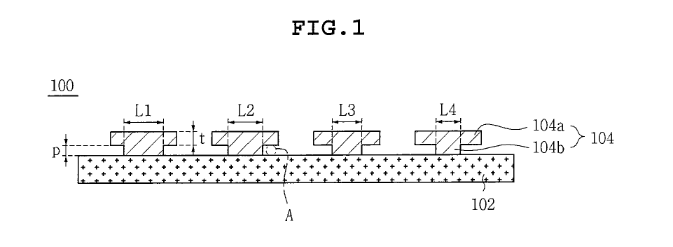

FIG. 1 is a sectional view of a touch panel 100 according to a preferred embodiment of the present invention.

As shown in FIG. 1, the touch panel 100 according to the preferred embodiment of the present invention is configured such that N transparent electrodes 104 are formed on one surface of a transparent substrate 102 and each of the transparent electrodes 104 includes a touch part 104a and a connection part 104b which are configured in a stepped form.

The transparent substrate 102 functions to support the transparent electrodes 104, and may be made of, but not limited to, polyethylene terephthalate (PET), polycarbonate (PC), polymethylmethacrylate (PMMA), polyethylenenaphthalate (PEN), Polyethersulfone (PES), cyclic olefin copolymer (COC), triacetylcellulose (TAC) films, polyvinyl alcohol (PVA) films, polyimide (PI) films, polystyrene (PS), biaxial oriented polystyrene (BOPS) containing K resin, glass, or tempered glass.

The transparent electrodes 104 generate signals when a user makes contact so that a controller (not shown) can recognize touch coordinates.

The transparent electrodes 104 are made of a conductive polymer which has excellent flexibility and is applied using a simple coating process.

In this case, the conductive polymer may include poly(3,4-ethylenedioxythiophene)/poly(styrenesulfonate) (PEDOT/PSS), Polyacetylene or polyphenylenevinylene.

Meanwhile, it is preferable to perform high-frequency processing or primer processing on one surface of the transparent substrate 102 so as to increase the activity of the surface (so as to improve adhesive power) before forming the transparent electrodes 104 on the surface of the transparent substrate 102.

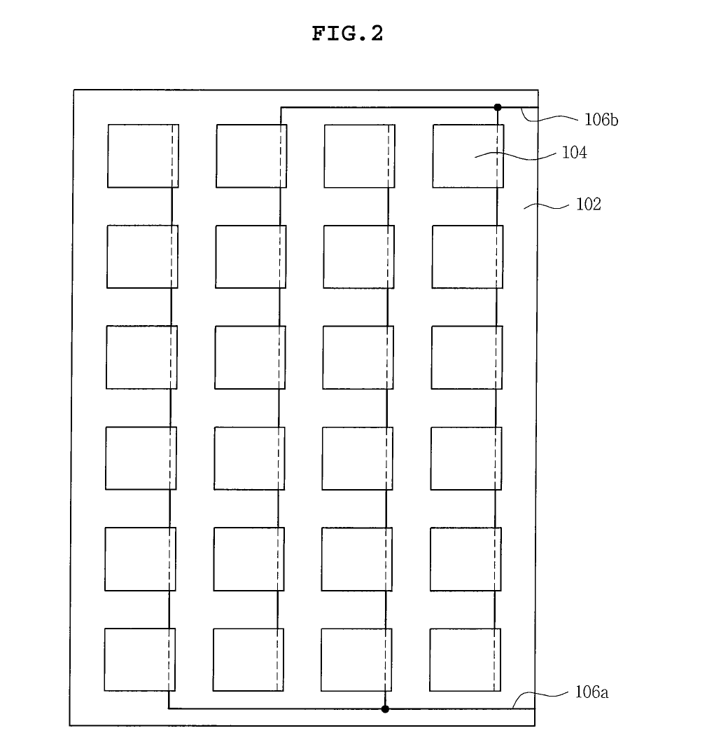

Each of the transparent electrodes 104 is configured to include a connection part 104b attached to the transparent substrate 102 and a touch part 104 formed on the connection part 104b to be integrated with the connection part 104b, as shown in FIG. 2.

Here, the touch part 104a and the connection part 104b are formed to have a T-shaped section in a stepped form.

Furthermore, the transparent electrodes 104 each including a touch part 104a and a connection part 104b are formed to have different capacitance values (or different resistance values).

For this purpose, the touch parts 104a are formed to have the same width (that is, the same longitudinal length and vertical length), and the connection parts 104b integrated with the touch parts 104a and electrically connecting the touch parts 104a with the transparent substrate 102 are formed to have different widths (for example, L1>L2>L3>L4).

Furthermore, the touch parts 104a may be formed to have the same thickness (or the same height; t) or different thicknesses (or heights), and the connection parts 104b are also formed to have the same thickness (or the same height; p) or different thicknesses (or heights).

When the touch parts 104a and the connection parts 104b are formed to have different thicknesses, the thicknesses of the touch parts 104a and the connection parts 104b are determined such that the transparent electrodes 104 have different capacitance values (or different resistance values).

Meanwhile, even when the transparent electrodes 104 each including a touch part 104a and a connection part 104b are configured such that the touch parts 104a and the connection parts 104b are formed to have the same thickness, the connection parts 104b are formed to have different widths, so that the transparent electrodes 104 have different capacitance values (or different resistance values).

The transparent electrodes 104 are arranged on one surface of the transparent substrate 102 in matrix form, as shown in FIGS. 2 and 3.

Here, the transparent electrodes 104 are connected by a wiring 106a or 106b for each column or row. As shown in FIG. 2, transparent electrodes 104 arranged in each odd column are connected to each other by the first wiring 106a, and transparent electrodes 104 arranged in each even column are connected to each other by the second wiring 106b.

Furthermore, as shown in FIG. 3, transparent electrodes 104 arranged in each odd row are connected to each other by the first wiring 106a, and transparent electrodes 104 arranged in each even row are connected to each other by the second wiring 106b.

Here, the first wiring 106a and the second wiring 106b are formed to be connected to the connection parts 104b. The first wiring 106a connects transparent electrodes 104, arranged in each odd row or column, to each other, and the second wiring 106b connects transparent electrodes 104, arranged in each even row or column, to each other.

Furthermore, the first wiring 106a and the second wiring 106b are configured not to overlap each other on the transparent substrate 102. As shown in FIGS. 2 and 3, it is preferred that the branches of the first wiring 106a and the branches of the second wiring 106b be merged on opposite sides.

That is, if the branches of the first wiring 106a each of which connects transparent electrodes 104 arranged in each odd column are configured to be merged on the upper side of the transparent substrate 102, the branches of the second wiring 106b each of which connects transparent electrodes 104 arranged in each even column are configured to be merged on the lower side of the transparent substrate 102. If the branches of the first wiring 106a are configured to be merged on the lower side of the transparent substrate 102, the branches of the second wiring 106b are configured to be merged on the upper side of the transparent substrate 102.

Furthermore, if the branches of the first wiring 106a each of which connects transparent electrodes 104 arranged in each odd row are configured to be merged on the left side of the transparent substrate 102, the branches of the second wiring 106b each of which connects transparent electrodes 104 arranged in each even row are configured to be merged on the right side of the transparent substrate 102. If the branches of the first wiring 106a are configured to be merged on the right side of the transparent substrate 102, the branches of the second wiring 106b are configured to be merged on the left side of the transparent substrate 102.

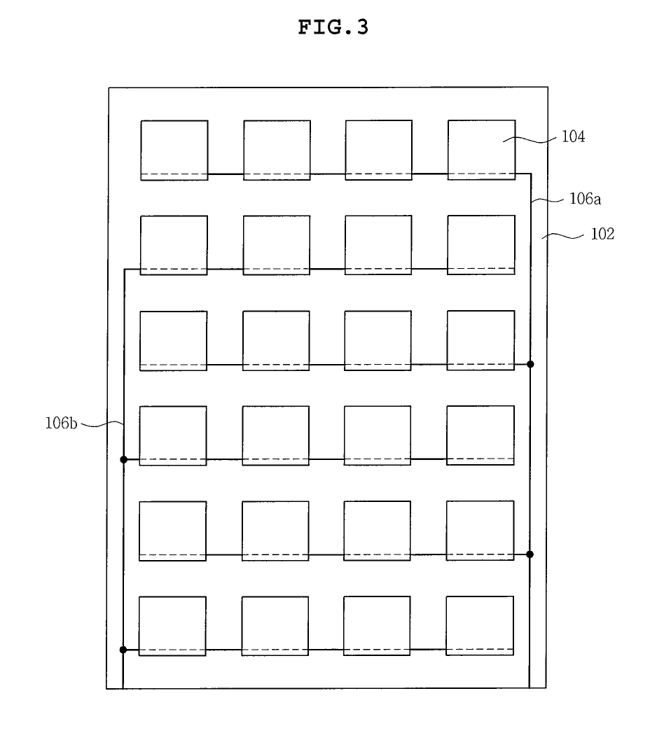

Although it is preferred that the first wiring 106a and the second wiring 106b be formed across spaces formed by the stepped form in which the touch parts 104a and the connection parts 104b are configured, as shown in FIG. 4, the first wiring 106a and the second wiring 106b may be formed between the transparent electrodes 104, as shown in FIG. 5.

Here, in order to form the first wiring 106a and the second wiring 106b across spaces A formed by the stepped form in which the touch parts 104a and the connection parts 104b are configured, the connection parts 104b should be formed to have the height, that is, the thickness, greater than the heights of the first wiring 106a and the second wiring 106b. It is preferred that the height of the connection parts 104b be determined to prevent signal interference between the transparent electrodes 104 including the touch parts 104a and the connection parts 104b and the wirings 106a and 106b.

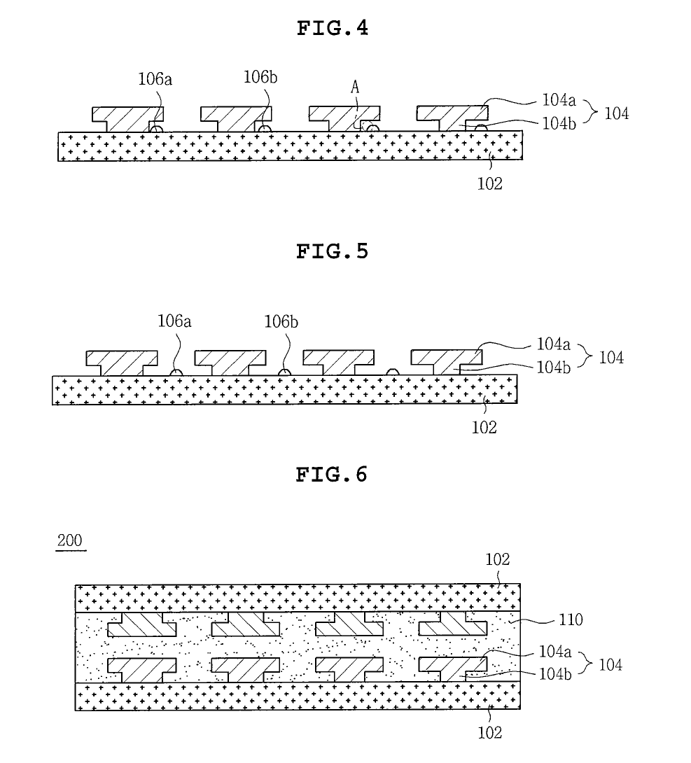

Meanwhile, the touch panel 100 according to the embodiment of the present invention, shown in FIG. 1, may be used to manufacture a mutual capacitance-type touch panel 200 in which two transparent substrates 102 on one surface of each of which transparent electrodes 104 are formed are provided and the two transparent substrates 102 are combined using a bonding layer 110 so that the transparent electrodes 104 face each other, as shown in FIG. 6, and may be used to manufacture a resistive-type touch panel 300, as shown in FIG. 7.

Here, the mutual capacitance-type touch panel 200 is configured such that the bonding layer 110 is applied to the entirety of the transparent electrodes 104 so that the opposite transparent electrodes 104 are insulated from each other. The resistive-type touch panel 300 is configured such that a bonding layer 110 is applied only to the edges of the transparent substrate 102 so that opposite transparent electrodes 104 come into contact with each other when a user applies pressure thereto and such that dot spacers 112 providing repulsive force are formed on transparent electrodes 104 formed on any one of the opposite transparent substrates 102 so that the transparent electrodes 104 can return to their original positions when the pressure applied by the user is removed.

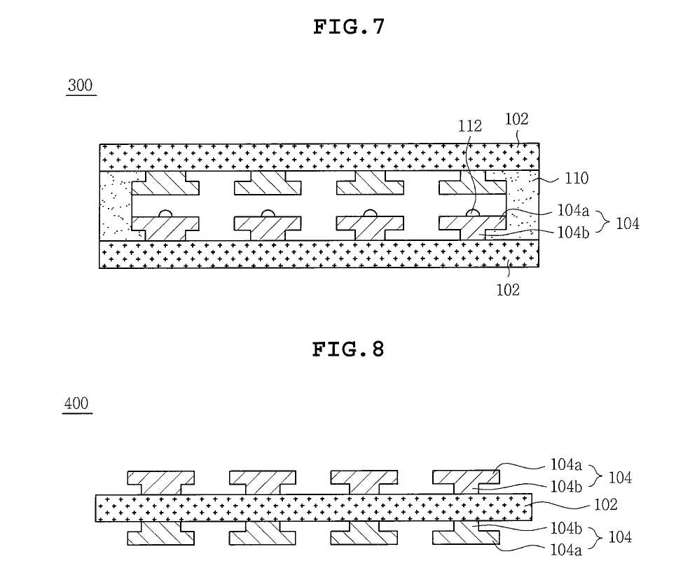

FIG. 8 is a sectional view of a touch panel 400 according to another preferred embodiment of the present invention.

As shown in FIG. 8, the touch panel 400 according to another preferred embodiment of the present invention is configured such that transparent electrodes 104 are formed on two opposite surfaces of a transparent substrate 102 and each of the transparent electrodes 104 includes a touch part 104a and a connection part 104b which are configured in a stepped form.

Since the structure and characteristics of the touch panel 400 according to the preferred embodiment of the present invention are the same as those of the touch panel 100 according to the embodiment of the present invention, shown in FIGS. 1 to 5, except for the structure in which the transparent electrodes 104 are formed on the two surfaces of the transparent substrate 102, a detailed description thereof is omitted here.

Since as described above, the touch panel according to the embodiment of the present invention is configured such that portions to be touched, that is, the touch parts 104a, are all formed to have the same size, the touch parts 104a and the connection parts 104b are configured in a stepped form, and the wirings connecting the transparent electrode 104 are disposed across spaces formed by the stepped form, the gaps between the transparent electrodes 104 can be reduced, thereby reducing the size of the touch panels.

According to the present invention, since the touch portions of the transparent electrodes are all formed to have the same width but to have different capacitance values and the wirings connecting the transparent electrodes are disposed across spaces formed by the stepped form in which the touch parts and the connection parts are configured, the gaps between the transparent electrodes can be reduced, thereby reducing the size of the touch panel.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A touch panel, comprising:
a transparent substrate; and
a plurality of transparent electrodes formed on one surface of the transparent substrate, each of the transparent electrodes comprising:
a touch part formed to have an identical width; and
a connection part configured in a stepped form along with the touch part, and configured to connect the touch part with the transparent substrate.

2. The touch panel as set forth in claim 1, wherein the transparent electrodes are formed to have different capacitance values.

3. The touch panel as set forth in claim 1, wherein the touch parts are formed to have an identical thickness.

4. The touch panel as set forth in claim 1, wherein the touch parts are formed to have different thicknesses.

5. The touch panel as set forth in claim 1, wherein the connection parts are formed to have different widths.

6. The touch panel as set forth in claim 1, wherein the connection parts are formed to have an identical thickness.

7. The touch panel as set forth in claim 1, wherein the connection parts are formed to have different thicknesses.

8. The touch panel as set forth in claim 1, wherein the touch part and the connection part are configured to have a T-shaped section.

9. The touch panel as set forth in claim 1, further comprising:
a first wiring configured to connect ones of the transparent electrodes, arranged in each odd column or row, to each other; and
a second wiring configured to connect ones of the transparent electrodes, arranged in each even column or row, to each other.

10. The touch panel as set forth in claim 9, wherein the first wiring and the second wiring are disposed across spaces formed by the stepped form in which the touch part and the connection part are configured.

11. The touch panel as set forth in claim 9, wherein the first wiring and the second wiring are disposed between the transparent electrodes.
